(19) United States
(12) Patent Application Publication
(10) Pub. No.: US 2025/0055524 A1
(43) Pub. Date: Feb. 13, 2025

(54) MOBILE COMMUNICATION SYSTEM AND CONTROL TERMINAL

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/929,168

(22) Filed: Oct. 28, 2024

Related U.S. Application Data
(63) Continuation of application No. PCT/JP2023/015304, filed on Apr. 17, 2023.

(30) Foreign Application Priority Data
Apr. 28, 2022 (JP) 2022-075425

(51) Int. Cl. H04B 7/06; H04B 7/04

(52) U.S. Cl. CPC H04B 7/0617; H04B 7/04026

(57) ABSTRACT

A mobile communication system includes a base station, a relay apparatus configured to relay a radio signal between the base station and a user equipment, and a control terminal configured to communicate with the base station and control the relay apparatus. The relay apparatus includes a plurality of elements used for beamforming. The control terminal performs, by grouping the plurality of elements into a plurality of groups, independent beam control for each of the plurality of groups. Information on the plurality of groups is communicated between the base station and the control terminal.

### RELATED APPLICATIONS

The present application is a continuation based on PCT Application No. PCT/JP2023/015304, filed on Apr. 17, 2023, which claims the benefit of Japanese Patent Application No. 2022-075425 filed on Apr. 28, 2022. The content of which is incorporated by reference herein in their entirety.

### TECHNICAL FIELD

The present disclosure relates to a mobile communication system and a control terminal.

### BACKGROUND

In recent years, a mobile communication system of the fifth-generation (5G) has been attracting attention. New Radio (NR), which is a radio access technology of the 5G system, is capable of broadband transmission via a high frequency band as opposed to Long Term Evolution (LTE), which is a fourth-generation radio access technology.

Since radio signals (radio waves) in the high frequency band such as a millimeter wave band or a terahertz wave band have higher propagation performance in a straight line, a problem exists in that the coverage of a base station needs to be reduced. In order to solve such a problem, a repeater apparatus is attracting attention that is a type of relay apparatuses relaying radio signals between a base station and a user equipment, and can be controlled from a network (see, for example, Non-Patent Document 1). Such a repeater apparatus can extend the coverage of the base station while mitigating occurrence of interference by, for example, amplifying a radio signal received from the base station and transmitting the radio wave through directional transmission.

### CITATION LIST

### Non-Patent Literature

Non-Patent Document 1: 3GPP Contribution: RP-213700, “New SI: Study on NR Network-controlled Repeaters”

### SUMMARY

A mobile communication system of a first aspect includes: a base station, a relay apparatus configured to relay a radio signal between the base station and a user equipment, and a control terminal configured to communicate with the base station and control the relay apparatus. The relay apparatus includes a plurality of elements used for beamforming. The control terminal performs, by grouping the plurality of elements into a plurality of groups, independent beam control for each of the plurality of groups. Information on the plurality of groups is communicated between the base station and the control terminal.

A control terminal of a second aspect is a control terminal configured to control a relay apparatus, the relay apparatus being configured to relay a radio signal between a base station and one or more user equipments and including a plurality of elements used for beamforming. The control terminal includes a controller configured to perform, by grouping the plurality of elements into a plurality of groups, independent beam control for each of the plurality of groups, and a communicator configured to communicate information on the plurality of groups with the base station.

### BRIEF DESCRIPTION OF THE DRAWINGS

FIG. 1 is a diagram illustrating a configuration of a mobile communication system according to an embodiment.

FIG. 2 is a diagram illustrating a protocol stack configuration of a radio interface in a user plane that handles data.

FIG. 3 is a diagram illustrating a protocol stack configuration of a radio interface in a control plane that handles signaling (control signal).

FIG. 4 is a diagram illustrating an application scenario for an NCR apparatus according to a first embodiment.

FIG. 5 is a diagram illustrating an application scenario for the NCR apparatus according to the first embodiment.

FIG. 6 is a diagram illustrating a control method of the NCR apparatus according to the first embodiment.

FIG. 7 is a diagram illustrating a configuration example of a protocol stack in the mobile communication system that includes the NCR apparatus and an NCR-UE according to the first embodiment.

FIG. 8 is a diagram illustrating a configuration example of the NCR-UE and the NCR apparatus according to the first embodiment.

FIG. 9 is a diagram illustrating a configuration example of a gNB according to the first embodiment.

FIG. 10 is a diagram illustrating an example of downlink signaling from the gNB to the NCR-UE according to the first embodiment.

FIG. 11 is a diagram illustrating an example of uplink signaling from the NCR-UE to the gNB according to the first embodiment.

FIG. 12 is a diagram for explaining a multi-beam operation of the NCR apparatus that is the relay apparatus according to the first embodiment.

FIG. 13 is a diagram illustrating an example of an operation of the mobile communication system according to the first embodiment.

FIG. 14 is a diagram for explaining an RIS apparatus according to a second embodiment.

FIG. 15 is a diagram for explaining the RIS apparatus according to the second embodiment.

FIG. 16 is a diagram for explaining the RIS apparatus according to the second embodiment.

FIG. 17 is a diagram illustrating configurations of an RIS-UE and the RIS apparatus according to the second embodiment.

FIG. 18 is a diagram for explaining a multi-beam operation of the RIS apparatus that is a relay apparatus according to the second embodiment.

### DESCRIPTION OF EMBODIMENTS

For a relay apparatus such as a repeater apparatus to be controlled from a network, a specific control technique for controlling the relay apparatus has not yet been established, and efficient coverage extension using the relay apparatus is currently difficult.

The present disclosure intends to provide appropriate control of a relay apparatus performing relay transmission between a base station and a user equipment.

A mobile communication system according to an embodiment is described with reference to the drawings. In the description of the drawings, the same or similar parts are denoted by the same or similar reference signs.

### (1) Overview of Embodiments

A mobile communication system according to a first aspect includes a base station, a relay apparatus configured to relay a radio signal between the base station and a user equipment, and a control terminal configured to communicate with the base station and control the relay apparatus. The relay apparatus includes a plurality of elements used for beamforming. The control terminal performs, by grouping the plurality of elements into a plurality of groups, independent beam control for each of the plurality of groups. Information on the plurality of groups is communicated between the base station and the control terminal.

A mobile communication system of a second aspect is the mobile communication system of the first aspect in which the relay apparatus is a repeater apparatus configured to amplify and transfer a received radio wave. Each of the plurality of elements includes an antenna of the repeater apparatus.

A mobile communication system of a third aspect is the mobile communication system of the first aspect in which the relay apparatus is a Reconfigurable Intelligent Surface (RIS) apparatus configured to change a propagation direction of an incident radio wave by reflection or refraction. Each of the plurality of elements includes a structure for the RIS apparatus.

In a mobile communication system of a fourth aspect, in the mobile communication system of any one of the first to third aspects, the control terminal is configured to transmit capability information including information indicating the number of the plurality of groups to the base station.

A mobile communication system of a fifth aspect is the mobile communication system of the fourth aspect in which the capability information further includes at least one selected from the group consisting of information indicating the number of the plurality of elements in each of the plurality of groups in the relay apparatus, the number of all the plurality of elements in the relay apparatus, an identifier of each of the plurality of groups in the relay apparatus, and information indicating beam characteristics of each of the plurality of groups in the relay apparatus.

According to a mobile communication system of a sixth aspect, in the mobile communication system of any one of the first to fifth aspects, the base station is configured to transmit to the control terminal a configuration message including a configuration related to the grouping.

A mobile communication system of a seventh aspect is the mobile communication system of the sixth aspect in which the configuration message includes at least one selected from the group consisting of information designating the number of the plurality of groups to be configured for the relay apparatus and/or the number of the beams to be configured for the relay apparatus, identifiers of one or more groups of the plurality of groups to be associated with each beam, and an identifier of the user equipment to be associated with each of the plurality of groups or each beam.

A mobile communication system of an eighth aspect is the mobile communication system of the sixth or seventh aspect in which the configuration message includes a plurality of the configurations that are switched in a time division manner.

A mobile communication system of a ninth aspect is the mobile communication system of the eighth aspect in which, in the configuration message, each of the plurality of the configurations is associated with a configuration identifier, and the base station transmits to the control terminal a control indication in which the configuration identifier designates a configuration of the plurality of the configurations to be applied.

A control terminal of a tenth aspect is a control terminal configured to control a relay apparatus, the relay apparatus being configured to relay a radio signal between a base station and one or more user equipments and including a plurality of elements used for beamforming. The control terminal includes a controller configured to perform, by grouping the plurality of elements into a plurality of groups, independent beam control for each of the plurality of groups, and a communicator configured to communicate information on the plurality of groups with the base station.

### (2) First Embodiment

A first embodiment will be described first. The relay apparatus according to the first embodiment is a repeater apparatus that can be controlled from a network.

### (2.1) Mobile Communication System Overview

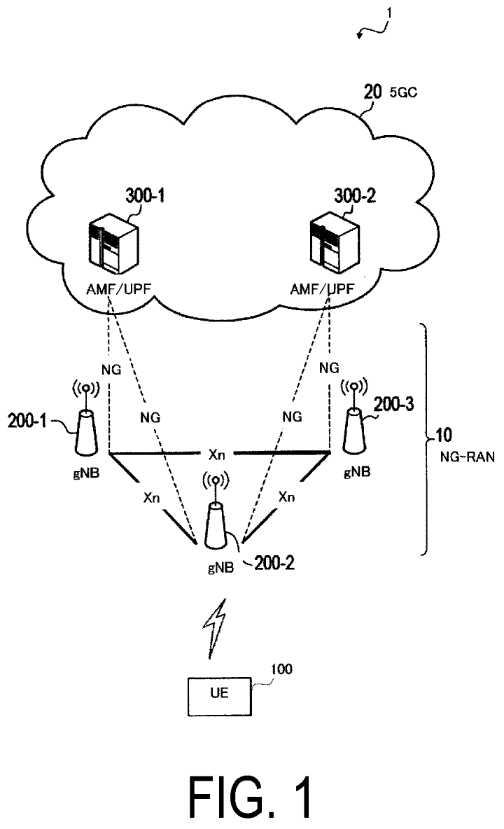

FIG. 1 is a diagram illustrating a configuration of a mobile communication system according to the first embodiment. A mobile communication system 1 complies with the 5th-Generation System (5GS) provided by the 3rd Generation Partnership Project (3GPP) (trade name, the same applies hereinafter) standard. The description below takes the 5GS as an example, but Long Term Evolution (LTE) system may be at least partially applied to the mobile communication system. A sixth-generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface, which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF performs data transfer control. The AMF and UPF are connected to the gNB 200 via an NG interface, which is an interface between a base station and the core network.

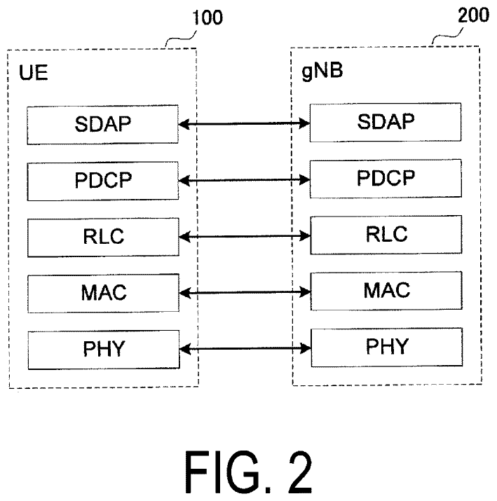

FIG. 2 is a diagram illustrating a protocol stack configuration of a radio interface in a user plane that handles data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH using a radio network temporary identifier (RNTI) and acquires successfully decoded DCI as DCI addressed to the UE 100. CRC parity bits scrambled by the RNTI are added to the DCI transmitted from the gNB 200.

The MAC layer performs priority control of data, retransmission processing through Hybrid Automatic Repeat reQuest (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

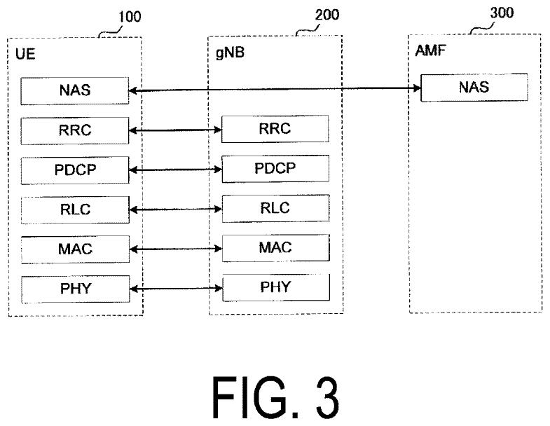

FIG. 3 is a diagram illustrating a protocol stack configuration of a radio interface in a control plane that handles signaling (control signal).

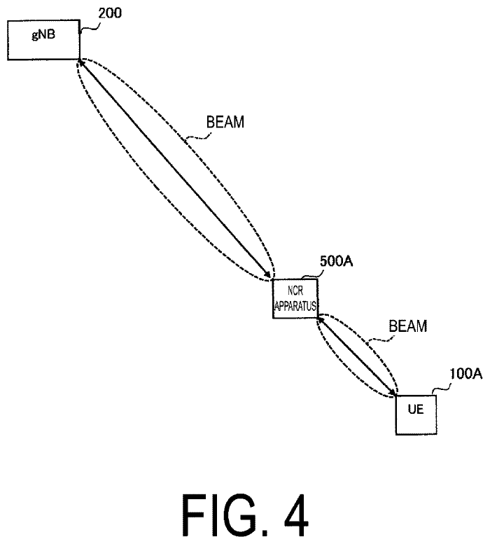

The protocol stack of the radio interface in the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### (2.2) Application Scenario of Relay Apparatus

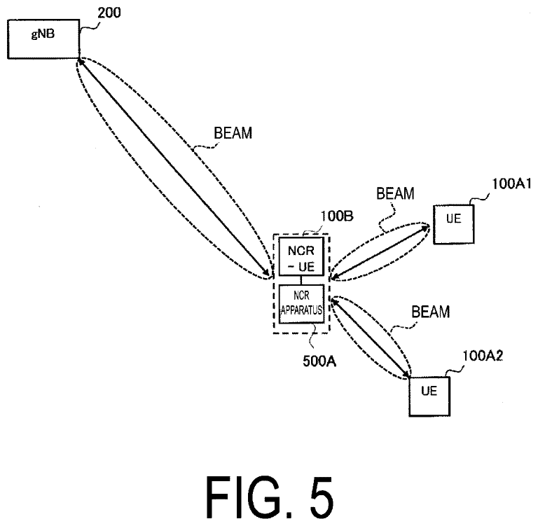

FIGS. 4 and 5 are diagrams illustrating application scenarios of the NCR apparatus according to the first embodiment.

The 5G/NR is capable of broadband transmission via a high frequency band compared to the 4G/LTE. Since radio signals in the high frequency band such as a millimeter wave band or a terahertz wave band have better performance of line-of-sight propagation, a problem exists in that the coverage of the gNB 200 needs to be reduced. In FIG. 4, a UE 100A may be located outside a coverage area of the gNB 200, for example, outside an area where the UE 100A can receive radio signals directly from the gNB 200. The UE 100A may be in a state where line-of-sight communication cannot be performed with the gNB 200 because of obstacles existing between the gNB 200 and the UE 100A.

In the first embodiment, a repeater apparatus (500A) is introduced into the mobile communication system 1, the repeater apparatus (500A) being a type of a relay apparatus that relays radio signals between the gNB 200 and the UE 100A and can be controlled from the network. Hereinafter, such a repeater apparatus is referred to as a Network-Controlled Repeater (NCR) apparatus. Such a repeater apparatus may be referred to as a smart repeater apparatus.

For example, an NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal and transmits the amplified radio signal through the directional transmission. Here, the NCR apparatus 500A may transmit a radio signal with a fixed directivity (beam). The NCR apparatus 500A may transmit a radio signal with a variable (adaptive) directional beam. This can efficiently extend the coverage of the gNB 200. In the first embodiment, although the main assumption is that the NCR apparatus 500A is applied to downlink communication from the gNB 200 to the UE 100A, the NCR apparatus 500A can also be applied to uplink communication from the UE 100A to the gNB 200.

As illustrated in FIG. 5, a new UE (hereinafter referred to as an “NCR-UE”) 100B is introduced that is a type of the control terminal for controlling the NCR apparatus 500A. The NCR-UE 100B controls the NCR apparatus 500A in cooperation with the gNB 200 by establishing a radio connection to the gNB 200 and performing wireless communication with the gNB 200. By doing so, efficient coverage extension can be achieved using the NCR apparatus 500A. The NCR-UE 100B controls the NCR apparatus 500A in accordance with control from the gNB 200.

The NCR-UE 100B may be configured to be a separate entity from the NCR apparatus 500A. For example, the NCR-UE 100B may be located near the NCR apparatus 500A and may be electrically connected to the NCR apparatus 500A. The NCR-UE 100B may be connected to the NCR apparatus 500A by wire or wirelessly. The NCR-UE 100B may be configured to be integrated with the NCR apparatus 500A. The NCR-UE 100B and the NCR apparatus 500A may be fixedly installed at a coverage edge (cell edge) of the base station 200, or on a wall surface or window of any building, for example. The NCR-UE 100B and the NCR apparatus 500A may be installed in, for example, a vehicle to be movable. One NCR-UE 100B may control a plurality of NCR apparatuses 500A.

In the example illustrated in FIG. 5, the NCR apparatus 500A dynamically or semi-statically changes a beam to be transmitted or received. For example, the NCR apparatus 500A forms a beam toward each of a UE 100A1 and a UE 100A2. The NCR apparatus 500A may also form a beam toward the gNB 200. For example, in a communication resource between the gNB 200 and the UE 100A1, the NCR apparatus 500A transmits a radio signal received from the gNB 200 toward the UE 100A1 through beamforming, and/or transmits a radio signal received from the UE 100A1 toward the gNB 200 through beamforming. In a communication resource between the gNB 200 and the UE 100A2, the NCR apparatus 500A transmits a radio signal received from the gNB 200 toward the UE 100A2 through beamforming, and/or transmits a radio signal received from the UE 100A2 toward the gNB 200 through beamforming. The NCR apparatus 500A may perform null forming (so-called null steering), instead of or in addition to the beamforming to mitigate interference, toward the UE 100 (not illustrated) that is not a communication partner and/or a neighboring gNB 200 (not illustrated).

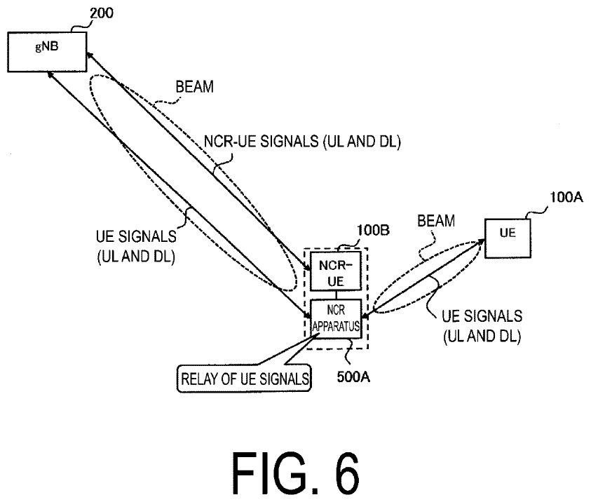

FIG. 6 is a diagram illustrating a control method of the NCR apparatus 500A according to the first embodiment. As illustrated in FIG. 6, the NCR apparatus 500A relays a radio signal (referred to as “UE signal”) between the gNB 200 and the UE 100A. The UE signal includes an uplink signal transmitted from the UE 100A to the gNB 200 (referred to as “UE-UL signal”) and a downlink signal transmitted from the gNB 200 to the UE 100A (referred to as “UE-DL signal”). The NCR apparatus 500A relays the UE-UL signal from the UE 100A to the gNB 200 and relays the UE-DL signal from the gNB 200 to the UE 100A.

The NCR-UE 100B transmits and receives a radio signal (referred to as “NCR-UE signal” here) to and from the gNB 200. The NCR-UE signal includes an uplink signal transmitted from the NCR-UE 100B to the gNB 200 (referred to as “NCR-UE-UL signal”) and a downlink signal transmitted from the gNB 200 to the NCR-UE 100B (referred to as “NCR-UE-DL signal”). The NCR-UE-UL signal includes signaling for controlling the NCR apparatus 500A.

The gNB 200 directs a beam toward the NCR-UE 100B based on the NCR-UE-UL signal from the NCR-UE 100B. Because the NCR apparatus 500A is co-located with the NCR-UE 100B, when the gNB 200 directs a beam to the NCR-UE 100B, the beam is consequently directed to both the NCR-UE 100B and the NCR apparatus 500A. The gNB 200 transmits the NCR-UE-DL signal and the UE-DL signal by using the beam. The NCR-UE 100B receives the NCR-UE-DL signal. Note that the NCR apparatus 500A and the NCR-UE 100B may be at least partially integrated. For example, in the NCR apparatus 500A and the NCR-UE 100B, functionalities (for example, antennas) for transmitting and receiving or relaying the UE signal and/or the NCR-UE signal are integrated. Note that the beam includes a transmission beam and/or a reception beam. The beam is a general term for transmission and/or reception to be controlled for maximizing the power of a transmission wave and/or a reception wave in a specific direction by adjusting/adapting an antenna weight or the like.

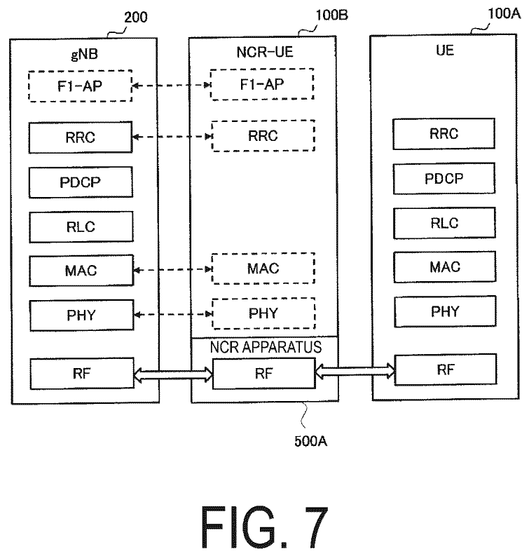

FIG. 7 is a diagram illustrating a configuration example of a protocol stack in the mobile communication system 1 that includes the NCR apparatus 500A and the NCR-UE 100B according to the first embodiment. The NCR apparatus 500A relays radio signals transmitted and received between the gNB 200 and the UE 100A. The NCR apparatus 500A has a Radio Frequency (RF) function of amplifying and relaying a received radio signal, and performs directional transmission through beamforming (for example, analog beamforming).

The NCR-UE 100B includes at least one layer (entity) selected from the group consisting of PHY, MAC, RRC, and F1-Application Protocol (AP). The F1-AP is a type of a fronthaul interface. The NCR-UE 100B communicates downlink signaling and/or uplink signaling, which will be described below, with the gNB 200 through at least one selected from the group consisting of the PHY, the MAC, RRC, and the F1-AP. When the NCR-UE 100B is a type or a part of the base station, the NCR-UE 100B may communicate with the gNB 200 through an AP of Xn (Xn-AP), which is an inter-base station interface.

### (2.3) Configuration Examples of Control Terminal and Relay Apparatus

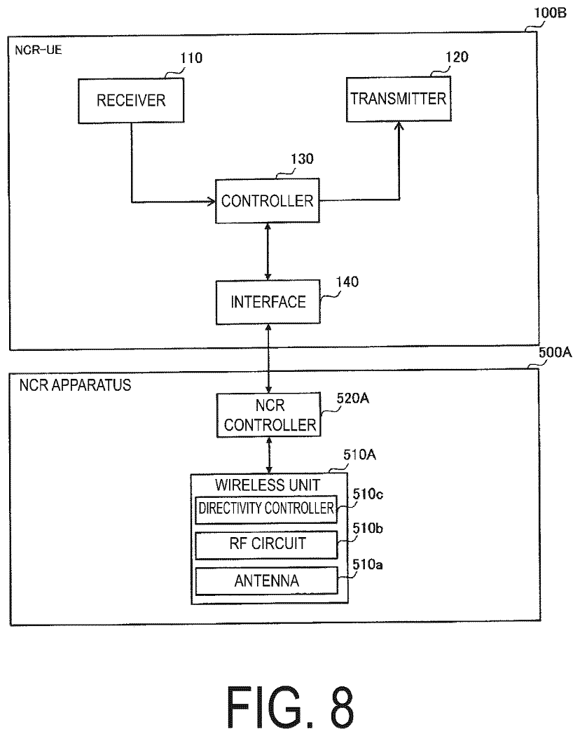

FIG. 8 is a diagram illustrating a configuration example of the NCR-UE 100B and the NCR apparatus 500A according to the first embodiment. The NCR-UE 100B includes a receiver 110, a transmitter 120, a controller 130, and an interface 140.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130. The transmitter 120 performs various types of transmission under control of the controller 130. The transmitter 120 includes an antenna and a transmission device. The transmission device converts a baseband signal (transmission signal) output by the controller 130 into a radio signal and transmits the resulting signal through the antenna.

The controller 130 performs various types of control in the NCR-UE 100B. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 130 performs a function of at least one layer selected from the group consisting of the PHY, the MAC, the RRC, and the F1-AP.

The interface 140 is electrically connected to the NCR apparatus 500A. The controller 130 controls the NCR apparatus 500A via the interface 140. Note that when the NCR-UE 100B and the NCR apparatus 500A are integrally configured, the NCR-UE 100B may not need to include the interface 140. The receiver 110 and the transmitter 120 of the NCR-UE 100B may be configured to be integrated with a wireless unit 510A of the NCR apparatus 500A.

The NCR apparatus 500A includes the wireless unit 510A and an NCR controller 520A. The wireless unit 510A includes an antenna 510a including a plurality of antennas (a plurality of antenna elements), an RF circuit 510b including an amplifier, and a directivity controller 510c controlling directivity of the antenna 510a. The RF circuit 510b amplifies and relays (transmits) radio signals transmitted and received by the antenna 510a. The RF circuit 510b may convert a radio signal, which is an analog signal, into a digital signal, and may reconvert the digital signal into an analog signal after digital signal processing. The directivity controller 510c may perform analog beamforming by analog signal processing. The directivity controller 510c may perform digital beamforming by digital signal processing. The directivity controller 510c may perform analog and digital hybrid beamforming.

The NCR controller 520A controls the wireless unit 510A in response to a control signal from the controller 130 of the NCR-UE 100B. The NCR controller 520A may include at least one processor. The NCR controller 520A may output information relating to a capability of the NCR apparatus 500A to the NCR-UE 100B. Note that when the NCR-UE 100B and the NCR apparatus 500A are integrally configured, the controller 130 of the NCR-UE 100B may also be configured to be integrated with the NCR controller 520A of the NCR apparatus 500A.

In the first embodiment, the receiver 110 of the NCR-UE 100B receives signaling (downlink signaling) used to control the NCR apparatus 500A from the gNB 200 through wireless communication. The controller 130 of the NCR-UE 100B controls the NCR apparatus 500A based on the signaling. This enables the gNB 200 to control the NCR apparatus 500A via the NCR-UE 100B.

In the first embodiment, the controller 130 of the NCR-UE 100B acquires NCR capability information indicating the capability of the NCR apparatus 500A from the NCR apparatus 500A (NCR controller 520A). The controller 130 may acquire the NCR capability information by reading the NCR capability information written in advance in a memory of the controller 130 itself. The transmitter 120 of the NCR-UE 100B transmits the acquired NCR capability information to the gNB 200 through wireless communication. The NCR capability information is an example of the uplink signaling from the NCR-UE 100B to the gNB 200. This enables the gNB 200 to recognize the capability of the NCR apparatus 500A.

### (2.4) Configuration Example of Base Station

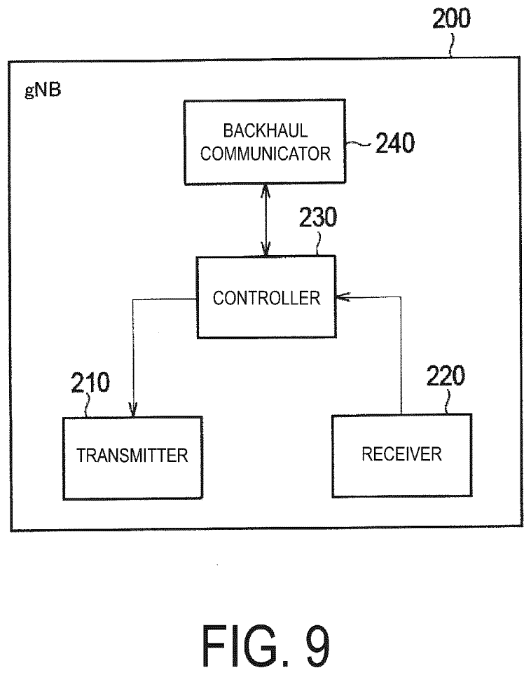

FIG. 9 is a diagram illustrating a configuration example of the gNB 200 according to the first embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna. The receiver 220 performs various types of reception under control of the controller 230. The receiver 220 includes an antenna and a reception device. The reception device converts a radio signal received through the antenna into a baseband signal (a reception signal) and outputs the resulting signal to the controller 230. The transmitter 210 and the receiver 220 may be capable of beamforming using a plurality of antennas.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions separately implemented), and both units may be connected via an F1 interface.

In the first embodiment, the transmitter 210 of the gNB 200 transmits signaling (downlink signaling) through wireless communication used to control the NCR apparatus 500A to the NCR-UE 100B controlling the NCR apparatus 500A. This enables the gNB 200 to control the NCR apparatus 500A via the NCR-UE 100B.

In the first embodiment, the receiver 220 of the gNB 200 receives the NCR capability information indicating the capability of the NCR apparatus 500A from the NCR-UE 100B controlling the NCR apparatus 500A through wireless communication. The NCR capability information is an example of the uplink signaling from the NCR-UE 100B to the gNB 200. This enables the gNB 200 to recognize the capability of the NCR apparatus 500A.

### (2.5) Example of Downlink Signaling

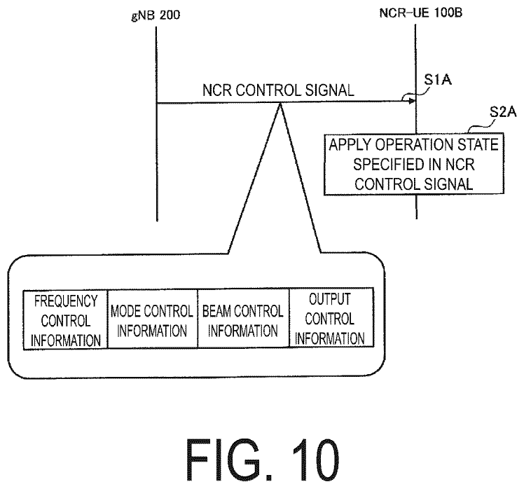

FIG. 10 is a diagram illustrating an example of the downlink signaling from the gNB 200 to the NCR-UE 100B according to the first embodiment.

The gNB 200 (transmitter 210) transmits downlink signaling to the NCR-UE 100B. The downlink signaling may be an RRC message that is RRC layer (i.e., layer-3) signaling. The downlink signaling may be MAC Control Element (CE) that is MAC layer (i.e., layer-2) signaling. The downlink signaling may be downlink control information (DCI) that is PHY layer (i.e., layer-1) signaling. The downlink signaling may be UE-specific signaling, or broadcast signaling. The downlink signaling may be a fronthaul message (for example, F1-AP message). When the NCR-UE 100B is a type or a part of the base station, the NCR-UE 100B may communicate with the gNB 200 through an AP of Xn (Xn-AP), which is an inter-base station interface.

For example, the gNB 200 (transmitter 210) transmits an NCR control signal designating an operation state of the NCR apparatus 500A as the downlink signaling to the NCR-UE 100B having established a radio connection to the gNB 200 (step S1A). The NCR control signal designating the operation state of the NCR apparatus 500A may be the MAC CE that is the MAC layer (layer-2) signaling or the DCI that is the PHY layer (layer-1) signaling. However, an RRC Reconfiguration message that is a type of a UE-specific RRC message may include the NCR control signal and be transmitted to the NCR-UE 100B. The downlink signaling may be a message of a layer (for example, an NCR application) higher than the RRC layer. The downlink signaling may be transmitting a message of a layer higher than the RRC layer encapsulated with a message of a layer equal to or lower than the RRC layer. Note that the NCR-UE 100B (transmitter 120) may transmit a response message in response to the downlink signaling from the gNB 200 in the uplink. The response message may be transmitted in response to the NCR apparatus 500A completing the configuration designated in the downlink signaling or receiving the configuration.

The NCR control signal may include frequency control information to designate a center frequency of a radio signal (for example, a component carrier) to be relayed by the NCR apparatus 500A. When the NCR control signal received from the gNB 200 includes the frequency control information, the NCR-UE 100B (controller 130) controls the NCR apparatus 500A such that a radio signal at a center frequency indicated by the frequency control information (step S2A) is to be relayed. The NCR control signal may include the plurality of pieces of frequency control information to designate center frequencies different from each other. Since the NCR control signal includes the frequency control information, the gNB 200 can designate the center frequency of the radio signal to be relayed by the NCR apparatus 500A via the NCR-UE 100B.

The NCR control signal may include mode control information to designate an operation mode of the NCR apparatus 500A. The mode control information may be associated with the frequency control information (center frequency). The operation mode may be any one of a mode in which the NCR apparatus 500A performs non-directional transmission and/or reception, a mode in which the NCR apparatus 500A performs fixed-directional transmission and/or reception, a mode in which the NCR apparatus 500A performs transmission and/or reception with a variable directional beam, and a mode in which the NCR apparatus 500A performs Multiple Input Multiple Output (MIMO) relay transmission. The operation mode may be either a beamforming mode (that is, a mode in which improvement of a desired wave is prioritized) and a null steering mode (that is, a mode in which mitigation of an interference wave is prioritized). When the NCR control signal received from the gNB 200 includes the mode control information, the NCR-UE 100B (controller 130) controls the NCR apparatus 500A such that the NCR apparatus 500A operates in the operation mode indicated by the mode control information (step S2A). Since the NCR control signal includes the mode control information, the gNB 200 can designate the operation mode of the NCR apparatus 500A via the NCR-UE 100B.

Here, the mode in which the NCR apparatus 500A performs non-directional transmission and/or reception is a mode in which the NCR apparatus 500A performs relay in all directions and may be referred to as an omnidirectional mode. The mode in which the NCR apparatus 500A performs fixed-directional transmission and/or reception may be a directivity mode realized by one directional antenna. The mode may be a beamforming mode realized by applying fixed phase and amplitude control (antenna weight control) to the plurality of antennas. Any of these modes may be designated (configured) from the gNB 200 to the NCR-UE 100B. The mode in which the NCR apparatus 500A performs transmission and/or reception with a variable directional beam may be a mode in which analog beamforming is performed, a mode in which digital beamforming or hybrid beamforming is performed. The mode may be a mode for forming an adaptive beam specific to the UE 100A. Any of these modes may be designated (configured) from the gNB 200 to the NCR-UE 100B. Note that in the operation mode in which beamforming is performed, beam control information described below may be provided from the gNB 200 to the NCR-UE 100B. The mode in which the NCR apparatus 500A performs MIMO relay transmission may be a mode in which Single-User (SU) spatial multiplexing is performed, a mode in which Multi-User (MU) spatial multiplexing is performed, or a mode in which transmission diversity is performed. Any of these modes may be designated (configured) from the gNB 200 to the NCR-UE 100B. The operation mode may include a mode in which relay transmission by the NCR apparatus 500A is turned on (activated) and a mode in which relay transmission by the NCR apparatus 500A is turned off (deactivated). Any of these modes may be designated (configured) from the gNB 200 to the NCR-UE 100B in the NCR control signal.

The NCR control signal may include the beam control information to designate a transmission direction, a transmission weight, or a beam pattern for the NCR apparatus 500A to perform directional transmission. The beam control information may be associated with the frequency control information (center frequency). The beam control information may include a Precoding Matrix Indicator (PMI). The beam control information may include beam forming angle information. When the NCR control signal received from the gNB 200 includes the beam control information, the NCR-UE 100B (controller 130) controls the NCR apparatus 500A such that the NCR apparatus 500A forms a transmission directivity (beam) indicated by the beam control information (step S2A). Since the NCR control signal includes the beam control information, the gNB 200 can control the transmission directivity of the NCR apparatus 500A via the NCR-UE 100B.

The NCR control signal may include output control information to designate a degree for the NCR apparatus 500A to amplify a radio signal (amplification gain) or transmission power. The output control information may be information indicating a difference value (that is, a relative value) between the current amplification gain or transmission power and the target amplification gain or transmission power. When the NCR control signal received from the gNB 200 includes the output control information, NCR-UE 100B (controller 130) controls the NCR apparatus 500A such that the amplification gain or transmission power is changed to an amplification gain or transmission power indicated by the output control information (step S2A). The output control information may be associated with the frequency control information (center frequency). The output control information may be information to designate any one of an amplification gain, a beamforming gain, and an antenna gain of the NCR apparatus 500A. The output control information may be information to designate the transmission power of the NCR apparatus 500A.

When one NCR-UE 100B controls a plurality of NCR apparatuses 500A, the gNB 200 (transmitter 210) may transmit the NCR control signal for each of the NCR apparatuses 500A to the NCR-UE 100B. In this case, the NCR control signal may include an identifier of the corresponding NCR apparatus 500A (NCR identifier). The NCR-UE 100B (controller 130) controlling the plurality of NCR apparatuses 500A determines the NCR apparatus 500A to which the NCR control signal is applied, based on the NCR identifier included in the NCR control signal received from the gNB 200. Note that the NCR identifier may be transmitted together with the NCR control signal from the NCR-UE 100B to the gNB 200 even when the NCR-UE 100B controls only one NCR apparatus 500A.

As described above, the NCR-UE 100B (controller 130) controls the NCR apparatus 500A based on the NCR control signal from the gNB 200. This enables the gNB 200 to control the NCR apparatus 500A via the NCR-UE 100B.

### (2.6) Example of Uplink Signaling

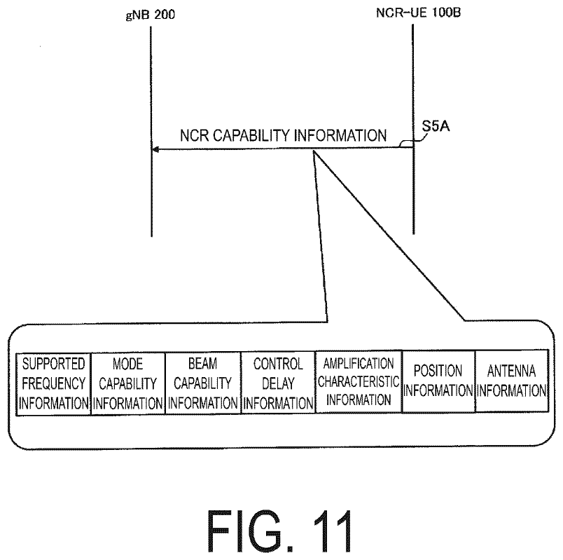

FIG. 11 is a diagram illustrating an example of the uplink signaling from the NCR-UE 100B to the gNB 200 according to the first embodiment.

The NCR-UE 100B (transmitter 210) transmits uplink signaling to the gNB 200. The uplink signaling may be an RRC message that is RRC layer signaling. The uplink signaling may be the MAC CE that is the MAC layer signaling. The uplink signaling may be uplink control information (UCI) that is PHY layer signaling. The uplink signaling may be the fronthaul message (for example, F1-AP message) or an inter-base station message (for example, Xn-AP message). The uplink signaling may be a message of a layer (for example, an NCR application) higher than the RRC layer. The uplink signaling may be transmitting a message of a layer higher than the RRC layer encapsulated with a message of a layer equal to or lower than the RRC layer. Note that the gNB 200 (transmitter 210) may transmit a response message in response to the uplink signaling from the NCR-UE 100B in the downlink, and the NCR-UE 100B (receiver 110) may receive the response message.

For example, the NCR-UE 100B (transmitter 120) having established a radio connection to the gNB 200 transmits the NCR capability information indicating the capability of the NCR apparatus 500A to the gNB 200 as the uplink signaling (step S5A). The NCR-UE 100B (transmitter 120) may include the NCR capability information in a UE Capability message or a UE Assistant Information message that is a type of the RRC message and transmit the NCR capability information to the gNB 200. The NCR-UE 100B (transmitter 120) may transmit the NCR capability information (NCR capability information and/or operation state information) to the gNB 200 in response to a request or inquiry from the gNB 200.

The NCR capability information may include supported frequency information indicating a frequency supported by the NCR apparatus 500A. The supported frequency information may be a numerical value or an index indicating a center frequency of the frequency supported by the NCR apparatus 500A. The supported frequency information may be a numerical value or an index indicating a range of the frequencies supported by the NCR apparatus 500A. When the NCR capability information received from the NCR-UE 100B includes the supported frequency information, the gNB 200 (controller 230) can recognize the frequency supported by the NCR apparatus 500A, based on the supported frequency information. The gNB 200 (controller 230) may configure the center frequency of the radio signal targeted by the NCR apparatus 500A within the range of the frequencies supported by the NCR apparatus 500A.

The NCR capability information may include mode capability information relating to the operation modes or switching between the operation modes that can be supported by the NCR apparatus 500A. The operation mode may be, as described above, at least any one selected from the group consisting of a mode in which the NCR apparatus 500A performs non-directional transmission and/or reception, a mode in which the NCR apparatus 500A performs fixed-directional transmission and/or reception, a mode in which the NCR apparatus 500A performs transmission and/or reception with a variable directional beam, and a mode in which the NCR apparatus 500A performs Multiple Input Multiple Output (MIMO) relay transmission. The operation mode may be either a beamforming mode (that is, a mode in which improvement of a desired wave is prioritized) or a null steering mode (that is, a mode in which suppression of an interference wave is prioritized). The mode capability information may be information indicating an operation mode among these operation modes the NCR apparatus 500A can support. The mode capability information may be information indicating, among these operation modes, operation modes between which the mode can be switched. When the NCR capability information received from the NCR-UE 100B includes the mode capability information, the gNB 200 (controller 230) can recognize the operation modes and mode switching supported by the NCR apparatus 500A, based on the mode capability information. The gNB 200 (controller 230) may configure the operation mode of the NCR apparatus 500A within a range of the recognized operation modes and mode switching.

The NCR capability information may include the beam capability information indicating a variable beam range, a variable beam resolution, or the number of variable patterns when the NCR apparatus 500A performs transmission and/or reception with a variable directional beam. The beam capability information may be, for example, information indicating a variable range of a beam angle with respect to the horizontal direction or the vertical direction (for example, being controllable from 30° to 90°). The beam capability information may be information indicating an absolute angle. The beam capability information may be represented by a direction of a beam and/or an elevation angle at which a beam is directed. The beam capability information may be information indicating an angular change per variable step (for example, horizontal 5°/step, vertical 10°/step). The beam capability information may be information indicating the number of variable steps (for example, horizontal 10 steps and vertical 20 steps). The beam capability information may be information indicating the number of variable patterns of a beam in the NCR apparatus 500A (for example, a total of 10 patterns of beam patterns 1 to 10). When the NCR capability information received from the NCR-UE 100B includes the beam capability information, the gNB 200 (controller 230) can recognize the beam angular change or beam patterns that can be supported by the NCR apparatus 500A, based on the beam capability information. The gNB 200 (controller 230) may configure a beam of the NCR apparatus 500A within a range of the recognized beam angular change or beam patterns. These pieces of beam capability information may be null capability information. In the null capability information, a null control capability when null steering is performed is indicated.

The NCR capability information may include control delay information indicating a control delay time in the NCR apparatus 500A. For example, the control delay information is information indicating a delay time (for example, 1 ms, 10 ms, and the like) from a timing at which the UE 100 receives the NCR control signal or a timing at which the UE 100 transmits to the gNB 200 configuration completion for the NCR control signal to completion control (operation mode change and/or beam change) in accordance with the NCR control signal. When the NCR capability information received from the NCR-UE 100B includes the control delay information, the gNB 200 (controller 230) can recognize the control delay time in the NCR apparatus 500A, based on the control delay information.

The NCR capability information may include amplification characteristic information relating to radio signal amplification characteristics or output power characteristics in the NCR apparatus 500A. The amplification characteristic information may be information indicating an amplifier gain (dB), a beamforming gain (dB), and an antenna gain (dBi) of the NCR apparatus 500A. The amplification characteristic information may be information indicating a variable amplification range (for example, 0 dB to 60 dB) in the NCR apparatus 500A. The amplification characteristic information may be information indicating the number of steps (for example, 10 steps) of the amplification magnitude that can be changed by the NCR apparatus 500A or the amplification magnitude for each variable step (for example, 10 dB/step). The amplification characteristic information may be information indicating a variable range of an output power (for example, 0 dBm to 30 dBm) of the NCR apparatus 500A. The amplification characteristic information may be information indicating the number of steps (for example, 10 steps) of the output power that can be changed by the NCR apparatus 500A or the output power for each variable step (for example, 10 dBm/step).

The NCR capability information may include position information indicating an installation location of the NCR apparatus 500A. The position information may include any one or more of latitude, longitude, and altitude. The position information may include information indicating a distance and/or an installation angle of the NCR apparatus 500A with respect to the gNB 200. The installation angle may be a relative angle with respect to the gNB 200, or a relative angle with respect to, for example, north, vertical, or horizontal. The installation location may be position information of a place where the antenna 510a of the NCR apparatus 500A is installed.

The NCR capability information may include antenna information indicating the number of antennas included in the NCR apparatus 500A. The antenna information may be information indicating the number of antenna ports included in the NCR apparatus 500A. The antenna information may be information indicating a degree of freedom of the directivity control (beam or null formation). The degree of freedom indicates how many beams can be formed (controlled) and is usually equal to the number obtained by “(the number of antennas)−1”. For example, in the case of two antennas, the degree of freedom is one. In the case of two antennas, an 8-shaped beam pattern is formed, but the directivity control can be performed only in one direction, so that the degree of freedom is one.

When the NCR-UE 100B controls a plurality of NCR apparatuses 500A, the NCR-UE 100B (transmitter 120) may transmit the NCR capability information for each NCR apparatus 500A to the gNB 200. In this case, the NCR capability information may include the number of NCR apparatuses 500A and/or an identifier of the corresponding NCR apparatus 500A (NCR identifier). When the NCR-UE 100B controls a plurality of NCR apparatuses 500A, the NCR-UE 100B (transmitter 120) may transmit information indicating the respective identifiers of the plurality of NCR apparatuses 500A and/or the number of the plurality of NCR apparatuses 500A. Note that the NCR identifier may be transmitted together with the NCR capability information from the NCR-UE 100B to the gNB 200 even when the NCR-UE 100B controls only one NCR apparatus 500A.

### (2.7) Multi-Beam Operation of Relay Apparatus

Here, it is assumed that the NCR apparatus 500A performs beamforming using the plurality of antennas (the plurality of antenna elements) included in the antenna 510a. Specifically, the NCR apparatus 500A simultaneously forms a plurality of beams using the plurality of antennas. The plurality of antennas is an example of the plurality of elements used for beamforming. For example, the NCR apparatus 500A forms an individual beam (independent beam) toward each of the UE 100A and the UE 100B as illustrated in FIG. 5. Under such an assumption, the NCR-UE 100B performs independent beam control for each group by grouping the plurality of antennas into the plurality of groups.

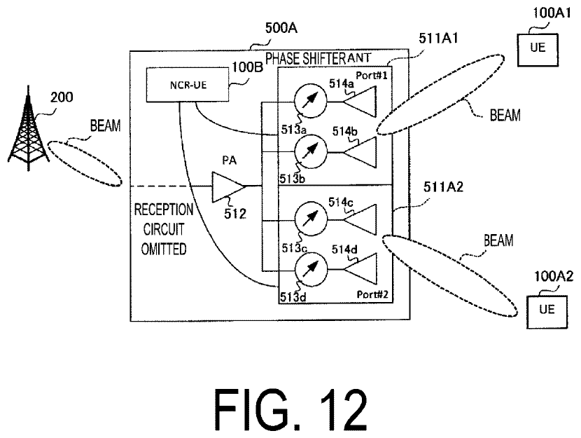

FIG. 12 is a diagram for explaining a multi-beam operation of the NCR apparatus 500A that is the relay apparatus according to the first embodiment. In FIG. 12, downlink communication is illustrated, and illustration of a configuration of a reception system (reception circuit and the like) in the NCR apparatus 500A is omitted. Note that a same and/or similar configuration may be applied to a reception circuit or may be applied to uplink communication. An example in which the NCR-UE 100B is configured to be integrated with the NCR apparatus 500A is illustrated.

The NCR apparatus 500A includes a power amplifier (PA) 512, a plurality of phase shifters 513 (513a to 513d), and a plurality of antennas 514 (514a to 514d) to configure a transmission system. The phase shifters 513 are provided in a one-to-one correspondence with the antennas 514. The phase shifters 513 and the antennas 514 are a part of the antenna 510a described above. Although an example in which the number of antennas 514 is four is illustrated in FIG. 12, the number of antennas 514 may be four or more. Although an example in which one PA 512 is provided is illustrated, four PAs 512 may be provided, and the plurality of PAs 512 may correspond to the antennas 514 on a one-to-one basis. Although a configuration of analog beamforming is illustrated in FIG. 12, digital beamforming by digital signal processing may be performed.

The PA 512 is a part of the RF circuit 510b described above. A signal received by the reception circuit is input to the PA 512. The PA 512 amplifies the input signal (transmission signal), and outputs the amplified transmission signal to each phase shifter 513. Each phase shifter 513 adjusts the phase of the transmission signal by multiplying the transmission signal by the antenna weight output from the directivity controller 510c described above, and outputs the phase-adjusted transmission signal to the corresponding antenna 514. Each antenna 514 radiates the input transmission signal to space as a radio wave.

With respect to the NCR apparatus 500A configured as described above, the NCR-UE 100B performs independent beam control for each group by grouping the plurality of antennas 514 (and the plurality of phase shifters 513) into a plurality of groups 511A (511A1 and 511A2). The PA 512 may be individually provided for each group 511A. Although an example in which the number of groups 511A is two is illustrated in FIG. 12, the number of groups may be three or more. Such a group may be referred to as “Port”. In that case, the group 511A1 may be Port #1 and the group 511A2 may be Port #2. The number of antennas 514 may be non-uniform among the groups. For example, the number of antennas 514 constituting Port #1 may be two, and the number of antennas 514 constituting Port #2 may be three. Further, the present invention is not limited to the configuration in which the antennas 514 that are physically adjacent to each other are grouped, and the antennas 514 that are not physically adjacent to each other may be grouped. Note that, although an example in which the transmission system is configured to be grouped into a plurality of groups has been described here, the reception system may be configured to be grouped into a plurality of groups in the same and/or similar manner.

The NCR-UE 100B may have an independent control interface for each group 511A. The NCR-UE 100B may perform beam control for each group 511A via the independent control interface for each group 511A. In the example of FIG. 12, the number of groups 511A is two, and the NCR-UE 100B controls such that one group 511A1 directs a beam to the UE 100A1 and the other group 511A2 directs a beam to the UE 100A2. Note that, N beams may be formed by using N groups.

The NCR-UE 100B may perform control to form one beam using all antennas 514 without performing such grouping. That is, the NCR-UE 100B may perform switching control of on and off of the grouping. When the grouping is performed, the NCR-UE 100B may individually configure the uplink signaling described above for each group 511A. For example, the NCR-UE 100B may individually configure the NCR capability information described above for each group 511A. In that case, the NCR-UE 100B may transmit the sets (one or more) of the group identifier and the NCR capability information to the gNB 200 as the uplink signaling. The gNB 200 may individually configure the downlink signaling described above for each group 511A. For example, the gNB 200 may individually configure the NCR control signal described above for each group 511A. In that case, the gNB 200 may transmit the sets (one or more) of the group identifier and the NCR control signal to the NCR-UE 100B as the downlink signaling.

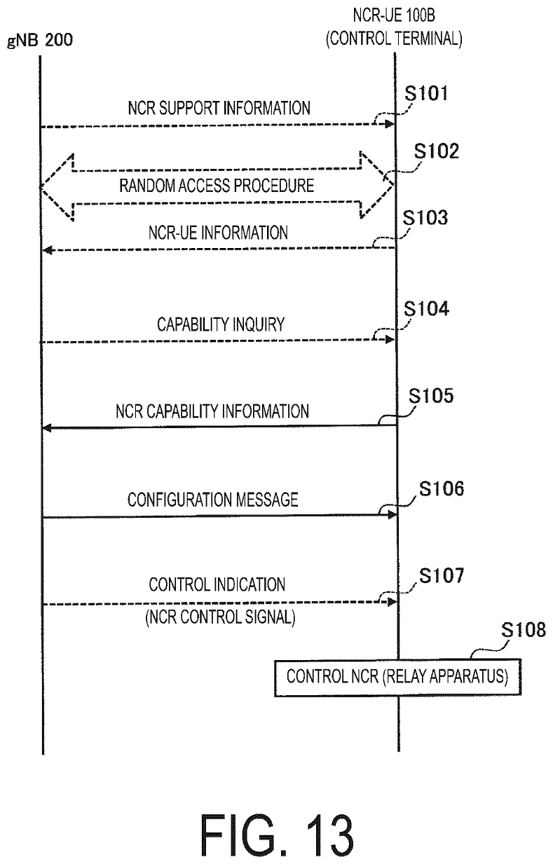

FIG. 13 is a diagram illustrating an example of an operation of the mobile communication system 1 according to the first embodiment. In FIG. 13, dashed lines indicate non-essential steps. Although description in detail will be made in a second embodiment, “NCR” in FIG. 13 may be interpreted as “RIS”.

In step S101, the gNB 200 (transmitter 210) broadcasts NCR support information indicating that the gNB 200 supports the NCR-UE 100B (and/or supports the grouping described above). For example, the gNB 200 (transmitter 210) broadcasts a system information block (SIB) including the NCR support information. The NCR support information may be information indicating that the NCR-UE 100B is allowed to perform access. The gNB 200 (transmitter 210) may broadcast NCR non-support information indicating that the gNB 200 does not support the NCR-UE 100B. The NCR non-support information may be information indicating that the NCR-UE 100B is not allowed to perform access.

In this stage, the NCR-UE 100B may be in the RRC idle state or the RRC inactive state. The NCR-UE 100B (controller 130) having not established a radio connection to the gNB 200 may determine that access to the gNB 200 is permitted in response to receiving the NCR support information from the gNB 200, and may perform an access operation to establish a radio connection to the gNB 200. The NCR-UE 100B (controller 130) may consider the gNB 200 (cell) which permits the access as the highest priority and perform cell reselection.

On the other hand, when the gNB 200 does not broadcast the NCR support information (or when the gNB 200 broadcasts the NCR non-support information), the NCR-UE 100B (controller 130) having not established a radio connection to the gNB 200 may determine that access (connection establishment) to the gNB 200 is not allowed. This enables the NCR-UE 100B to establish a radio connection only to the gNB 200 capable of handling the NCR-UE 100B.

Note that when the gNB 200 is congested, the gNB 200 may broadcast access restriction information to restrict an access from the UE 100. However, unlike a normal UE 100, the NCR-UE 100B can be considered as a network-side entity. Therefore, the NCR-UE 100B may ignore the access restriction information from the gNB 200. For example, the NCR-UE 100B (controller 130), when receiving the NCR support information from the gNB 200, may perform an operation to establish a radio connection to the gNB 200 even if the gNB 200 broadcasts the access restriction information. For example, the NCR-UE 100B (controller 130) may not need to perform (or may ignore) Unified Access Control (UAC). Alternatively, any one or both of Access Category/Access Identity (AC/AI) used in the UAC may be a special value indicating that the access is made by the NCR-UE.

In step S102, the NCR-UE 100B (controller 130) starts a random access procedure for the gNB 200. In the random access procedure, the NCR-UE 100B (transmitter 120) transmits a random access preamble (Msg1) and an RRC message (Msg3) to the gNB 200. In the random access procedure, the NCR-UE 100B (receiver 110) receives a random access response (Msg2) and an RRC message (Msg4) from the gNB 200.

In step S103, when establishing a radio connection to the gNB 200, the NCR-UE 100B (transmitter 120) may transmit to the gNB 200 NCR-UE information indicating that the NCR-UE 100B itself is an NCR-UE. For example, the NCR-UE 100B (transmitter 120), during the random access procedure with the gNB 200, includes the NCR-UE information in the message (for example, Msg1, Msg3, Msg5) for the random access procedure and transmits the NCR-UE information to the gNB 200. The gNB 200 (controller 230) can recognize that the UE 100 that has performed the access is the NCR-UE 100B, based on the NCR-UE information received from the NCR-UE 100B, and exclude from the access restriction target (in other words, accept the access from) the NCR-UE 100B, for example. Upon completion of the random access procedure, the NCR-UE 100B transitions from the RRC idle state or the RRC inactive state to the RRC connected state.

In step S104, the gNB 200 (transmitter 120) transmits to the NCR-UE 100B a capability inquiry message to inquire the capability of the NCR-UE 100B. The NCR-UE 100B (receiver 110) receives the capability inquiry message.

In step S105, the NCR-UE 100B (transmitter 120) transmits a capability information message including the NCR capability information to the gNB 200. The capability information message may be an RRC message, that is, for example, a UE Capability message. The gNB 200 (receiver 220) receives the capability information message. The gNB 200 (controller 230) recognizes the capability of the NCR apparatus 500A based on the received capability information message. The NCR capability information (capability information message) includes information indicating the number of groups 511A in the NCR apparatus 500A. The information may be information indicating the maximum number of groups and/or information indicating the minimum number of groups, of the grouping. The NCR capability information (capability information message) may further include at least one selected from the group consisting of information indicating the number of elements (for example, antennas 514) in each group 511A in the NCR apparatus 500A, the number of all elements in the NCR apparatus 500A, an identifier of each group 511A, and information indicating beam characteristics of each group 511A. The information indicating the beam characteristics may be, for example, a part of the NCR capability information described above.

In step S106, the gNB 200 (transmitter 210) transmits the configuration message including various configurations related to the NCR apparatus 500A to the NCR-UE 100B. The NCR-UE 100B (receiver 110) receives the configuration message. The configuration message is a type of the downlink signaling described above. The configuration message may be an RRC message, that is, for example, a RRC Reconfiguration message. The configuration message includes a configuration related to grouping.

For example, the configuration message may include information designating the number of groups 511A to be configured for the NCR apparatus 500A and/or the number of beams to be configured for the NCR apparatus 500A. The information may include an identifier (group identifier) of the group 511A to be configured for the NCR apparatus 500A. The number of group identifiers may implicitly indicate the number of groups 511A to be configured for the NCR apparatus 500A and/or the number of beams to be configured for the NCR apparatus 500A. The configuration message may include information for designating on and off of the grouping. The configuration message may include information designating the number of elements (for example, antennas 514) constituting each group 511A.

Two or more groups may be configured to form one beam. For example, two beams may be configured for the NCR apparatus 500A supporting six groups, that is, one beam may be formed for every three groups. In that case, the configuration message may include identifiers of one or more groups 511A associated with each beam.

With respect to the group identifier in the configuration message, when the gNB 200 is notified of the group identifier by the capability information described above, the group identifier may be diverted. On the other hand, when the gNB 200 is not notified of the group identifier in the capability information, the gNB 200 may assign the group identifier.

The configuration message may include an identifier of the UE 100A to be associated with each group or each beam.

The configuration message may include a plurality of configurations to be switched in a time division manner as the configuration related to the grouping described above. For example, the configuration related to the grouping may be dynamically switched by a control indication to be described later. In this case, the configuration message may include indexes (configuration identifiers) associated with the various configurations.

In step S107, the gNB 200 (transmitter 210) transmits the control indication designating the operation state of the NCR apparatus 500A to the NCR-UE 100B. The control indication may be the NCR control signal (for example, L1/L2 signaling) described above. The NCR-UE 100B (receiver 110) receives the control indication. The NCR-UE 100B (controller 130) controls the NCR apparatus 500A in response to the control indication. The control indication may include a group identifier of the group 511A to be controlled. In that case, the NCR-UE 100B (controller 130) applies the operation state designated by the control indication to the group 511A indicated by the group identifier. The control indication may include an index (configuration identifier) indicating a configuration to be switched (configuration after switching). In that case, the NCR-UE 100B (controller 130) controls the NCR apparatus 500A to switch to the configuration indicated by the index among the plurality of configurations configured by the configuration message.

In step S108, the NCR-UE 100B controls the NCR apparatus 500A in accordance with the configuration (and control indication) described above. The NCR-UE 100B may autonomously control the NCR apparatus 500A without depending on the control indication from the gNB 200 for at least one group 511A. For example, the NCR-UE 100B may autonomously control the NCR apparatus 500A based on the location of the UE 100A and/or information that the NCR-UE 100B receives from the UE 100A.

### (3) Second Embodiment

With respect to a second embodiment, differences from the first embodiment described above are mainly described. The overview of a mobile communication system 1 and the configuration of a gNB 200 according to the second embodiment each are the same as and/or similar to that of the first embodiment described above.

A relay apparatus according to the second embodiment is a Reconfigurable Intelligent Surface (RIS) apparatus configured to change a propagation direction of an incident radio wave (radio signal) by reflection or refraction. The “NCR” in the first embodiment described above may be interpreted as the “RIS”. The RIS can perform beamforming (directivity control) in the same manner as the NCR by changing the characteristics of metamaterial. In the case of the RIS, by controlling the reflection direction and/or the refraction direction of each unit element, the range (distance) of a beam may be changeable in the same manner as a lens. For example, the RIS may be configured to control the reflection direction and/or the refraction direction of each unit element, and focus on (direct a beam to) a near UE or focus on (direct a beam to) a far UE.

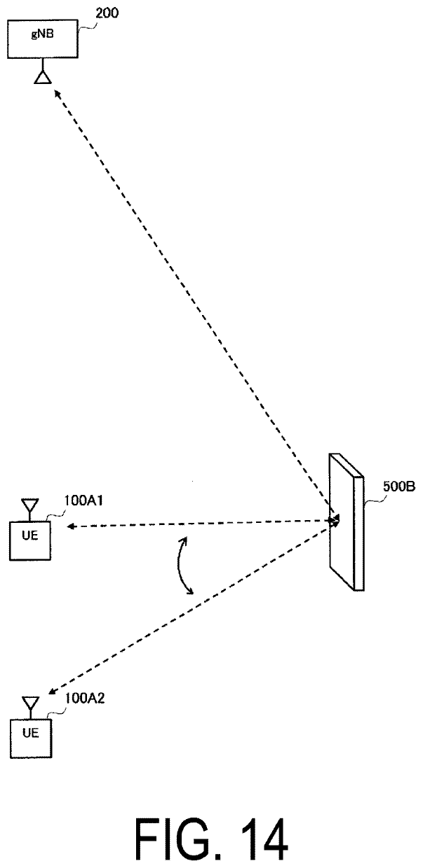

As illustrated in FIG. 14, an RIS apparatus 500B according to the second embodiment may be a reflective RIS apparatus 500B. Such an RIS apparatus 500B reflects an incident radio wave to change the propagation direction of the radio wave. Here, a reflection angle of the radio wave can be variably configured. The RIS apparatus 500B reflects the incident radio wave from the gNB 200 toward each of the UE 100A1 and the UE 100A2. The RIS apparatus 500B may reflect the incident radio wave from each of the UE 100A1 and the UE 100A2 toward the gNB 200. The RIS apparatus 500B dynamically changes the reflection angle of the radio wave. For example, in a communication resource between the gNB 200 and the UE 100A1, the RIS apparatus 500B reflects the incident radio wave from the gNB 200 toward the UE 100A1 and/or reflects the incident radio wave from the UE 100A1 toward the gNB 200. Here, the communication resource includes a time direction resource and/or a frequency direction resource. In a communication resource between the gNB 200 and the UE 100A2, the RIS apparatus 500B reflects the incident radio wave from the gNB 200 toward the UE 100A2 and/or reflects the incident radio wave from the UE 100A2 toward the gNB 200.

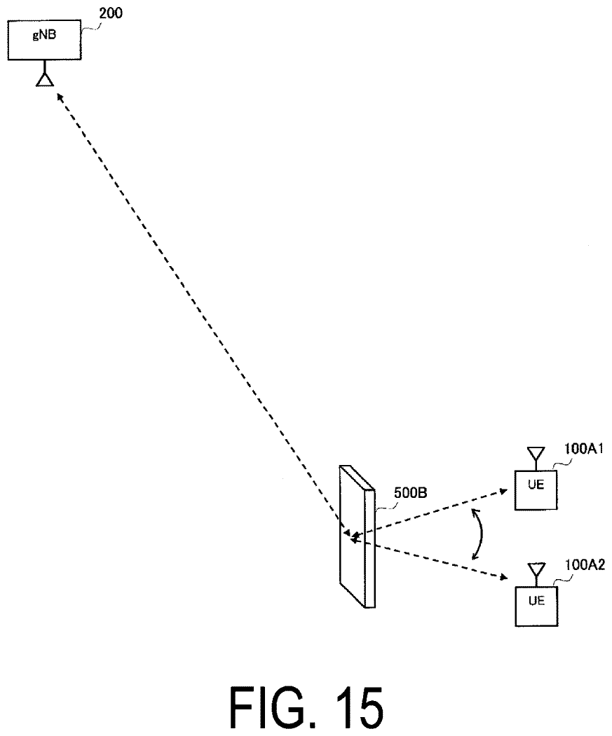

As illustrated in FIG. 15, the RIS apparatus 500B may be a transmissive RIS apparatus 500B. Such an RIS apparatus 500B refracts an incident radio wave to change the propagation direction of the radio wave. Here, a refraction angle of the radio wave can be variably configured. The RIS apparatus 500B refracts the incident radio wave from the gNB 200 toward each of the UE 100A1 and the UE 100A2. The RIS apparatus 500B may refract the incident radio wave from each of the UE 100A1 and the UE 100A2 toward the gNB 200. The RIS apparatus 500B dynamically changes the refraction angle of the radio wave. For example, in a communication resource between the gNB 200 and the UE 100A1, the RIS apparatus 500B refracts the incident radio wave from the gNB 200 toward the UE 100A1 and/or refracts the incident radio wave from the UE 100A1 toward the gNB 200. In a communication resource between the gNB 200 and the UE 100A2, the RIS apparatus 500B refracts the incident radio wave from the gNB 200 toward the UE 100A2 and/or refracts the incident radio wave from the UE 100A2 toward the gNB 200.

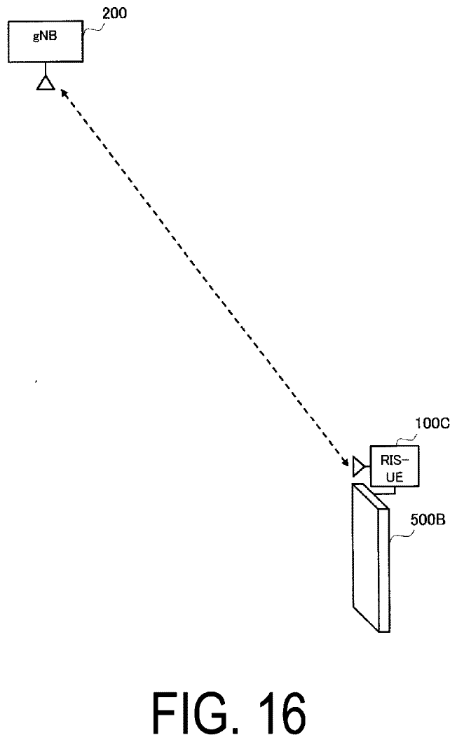

As illustrated in FIG. 16, in the second embodiment, a new UE (hereinafter referred to as “RIS-UE”) 100C is introduced that is a control terminal for controlling the RIS apparatus 500B. The RIS-UE 100C controls the RIS apparatus 500B in cooperation with the gNB 200 by establishing a radio connection to the gNB 200 and performing wireless communication with the gNB 200. This can realize efficient coverage extension using the RIS apparatus 500B while mitigating the increase in the installation cost and the decrease in the degree of freedom of the installation of the RIS apparatus 500B. The RIS-UE 100C controls the RIS apparatus 500B in accordance with an RIS control signal from the gNB 200.

The RIS-UE 100C may be configured to be a separate entity from the RIS apparatus 500B. For example, the RIS-UE 100C may be located near the RIS apparatus 500B and may be electrically connected to the RIS apparatus 500B. The RIS-UE 100C may be connected to the RIS apparatus 500B by wire or wirelessly. The RIS-UE 100C may be configured to be integrated with the RIS apparatus 500B. The RIS-UE 100C and the RIS apparatus 500B may be, for example, fixedly installed on a wall surface or a window. The RIS-UE 100C and the RIS apparatus 500B may be, for example, installed in a vehicle to be movable. One RIS-UE 100C may control a plurality of RIS apparatuses 500B.

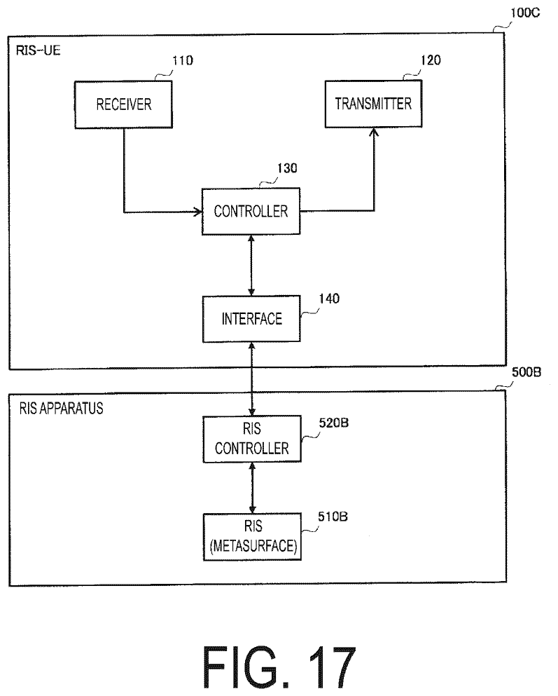

FIG. 17 is a diagram illustrating configurations of the RIS-UE 100C and the RIS apparatus 500B according to the second embodiment. As illustrated in FIG. 17, the RIS-UE 100C includes a receiver 110, a transmitter 120, a controller 130, and an interface 140. Such a configuration is the same as and/or similar to that in the first embodiment described above.

The RIS apparatus 500B includes an RIS 510B and an RIS controller 520B. The RIS 510B is a metasurface configured using metamaterials. For example, the RIS 510B is configured to include structures arranged in an array form, each of the structures being very small relative to a wavelength of a radio wave and include different shapes of structures depending on the arrangement position, thus making it possible to design any direction and/or any beam shape of a reflected wave. The RIS 510B may be a transparent dynamic metasurface. The RIS 510B may be configured to include a transparent glass substrate stacked on a metasurface substrate on which a large number of small structures are arranged in a regular arrangement and which is made transparent, and allow the microscopic movement of the stacked glass substrate, thus making it possible to dynamically control three patterns of modes including a mode of transmitting an incident radio wave, a mode of transmitting a part of a radio wave and reflecting a part thereof, and a mode of reflecting all radio waves.

The RIS controller 520B controls the RIS 510B in response to an RIS control signal from the controller 130 in the RIS-UE 100C. The RIS controller 520B may include at least one processor and at least one actuator. The processor interprets the RIS control signal from the controller 130 in the RIS-UE 100C to drive the actuator in response to the RIS control signal. Note that when the RIS-UE 100C and the RIS apparatus 500B are integrally configured, the controller 130 in the RIS-UE 100C and the RIS controller 520B in the RIS apparatus 500B may also be integrally configured.

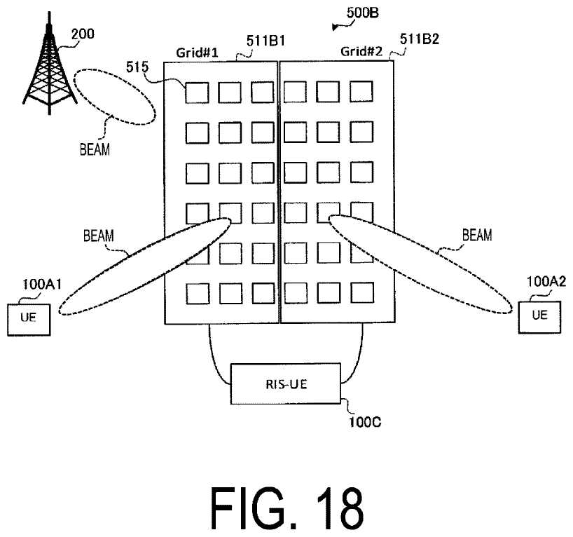

FIG. 18 is a diagram for explaining a multi-beam operation of the RIS apparatus 500B that is the relay apparatus according to the second embodiment. In FIG. 18, the downlink communication is illustrated.

The RIS apparatus 500B includes multiple structures 515 that are arranged in a periodic manner in horizontal and vertical directions. The plurality of structures 515 is an example of the plurality of elements used for beamforming. The RIS apparatus 500B realizes electromagnetic characteristics not existing in nature by arranging the structures 515 in a periodic manner. Desired characteristics (for example, bending radio waves in any direction) are obtained by adjusting the shapes and/or the electromagnetic characteristics of the structures 515.

With respect to the RIS apparatus 500B configured as described above, the RIS-UE 100C performs independent beam control for each group by grouping the plurality of structures 515 into a plurality of groups 511B (511B1 and 511B2). Although an example in which the number of groups 511B is two is illustrated in FIG. 18, the number of groups may be three or more. Such a group may be referred to as a “grid”. In that case, the group 511B1 may be a Grid #1, and the group 511B2 may be a Grid #2. The number of structures 515 may be non-uniform among the groups. Note that, although the structures 515 that are physically adjacent to each other are grouped, the structures 515 that are not physically adjacent to each other may be grouped, that is, for example, alternately grouped every other structure.

The RIS-UE 100C may have an independent control interface for each group 511B. The RIS-UE 100C may perform beam control for each group 511B via the independent control interface for each group 511B. In the example of FIG. 18, the number of groups 511B is two, and the RIS-UE 100C performs control such that one group 511B1 directs a beam to UE 100A1 and the other group 511B2 directs a beam to UE 100A2. Note that, N beams may be formed by using N groups.

The RIS-UE 100C may perform control to form one beam using all the structures 515 without such grouping. That is, the RIS-UE 100C may perform switching control of on and off of the grouping. When the grouping is performed, the RIS-UE 100C may individually configure the uplink signaling as described above for each group 511B. For example, the RIS-UE 100C may individually configure the capability information described above for each group 511B. In that case, the RIS-UE 100C may transmit the sets (one or more) of the group identifier and the NCR capability information to the gNB 200 as the uplink signaling. The gNB 200 may individually configure the downlink signaling as described above for each group 511B. For example, the gNB 200 may individually configure a control signal similar to the NCR control signal described above for each group 511B. In that case, the gNB 200 may transmit the sets (one or more) of the group identifier and the NCR control signal to the RIS-UE 100C as the downlink signaling.

### (4) Other Embodiments

The NCR/RIS control information transmitted from the gNB 200 to the NCR-UE 100B or the RIS-UE 100C may be information for controlling a direction and/or a focal distance of a beam relayed (output) by the NCR apparatus 500A or the RIS apparatus 500B. The information for controlling the direction is, for example, the antenna weight as described above. The information for controlling the focal distance is information for the NCR apparatus 500A or the RIS apparatus 500B to focus the beam in accordance with the distance between the NCR apparatus 500A or the RIS apparatus 500B and the UE 100A. Such information may be information indicating the distance between the NCR apparatus 500A or the RIS apparatus 500B and the UE 100A. Such information may be information indicating a focal distance (for example, a focal range such as near or far). The NCR apparatus 500A or the RIS apparatus 500B adjusts the focal distance of the beam based on the information. In the case of the RIS apparatus 500B, by controlling (differentiating) the reflection (or refraction) angle of elements outside the surface of the metasurface and the reflection (or refraction) angle of elements inside the surface of the metasurface to be different angles, the focal distance of the beam is adjusted like a lens.

In the embodiment described above, the frequency control information may include a cell ID identifying a cell and/or a BWP ID identifying a bandwidth part (BWP). The BWP is a part of a frequency band of a cell.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node.

A program causing a computer to execute each of the processes performed by the UE 100 (NCR-UE 100B, RIS-UE 100C) or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure.

### Supplementary Note

Features relating to the embodiments described above are described below as supplements.

(1)

A mobile communication system, including:
a base station;
a relay apparatus configured to relay a radio signal between the base station and a user equipment; and
a control terminal configured to communicate with the base station and control the relay apparatus,
wherein the relay apparatus includes a plurality of elements used for beamforming,
the control terminal performs, by grouping the plurality of elements into a plurality of groups, independent beam control for each of the plurality of groups, and
information on the plurality of groups is communicated between the base station and the control terminal.
   (2)

The mobile communication system according to (1) described above,
wherein the relay apparatus is a repeater apparatus configured to amplify and transfer a received radio wave, and each of the plurality of elements includes an antenna of the repeater apparatus.
   (3)

The mobile communication system according to (1) or (2) described above,
wherein the relay apparatus is a Reconfigurable Intelligent Surface (RIS) apparatus configured to change a propagation direction of an incident radio wave by reflection or refraction, and
each of the plurality of elements includes a structure for the RIS apparatus.
   (4)

The mobile communication system according to any one of (1) to (3) described above,
wherein the control terminal is configured to transmit capability information including information indicating the number of the plurality of groups to the base station.
   (5)

The mobile communication system according to (4) described above,
wherein the capability information further includes at least one selected from the group consisting of information indicating the number of the plurality of elements in each of the plurality of groups in the relay apparatus, the number of all the plurality of elements in the relay apparatus, an identifier of each of the plurality of groups in the relay apparatus, and information indicating beam characteristics of each of the plurality of groups in the relay apparatus.
   (6)

The mobile communication system according to any one of (1) to (3) described above,
wherein the base station is configured to transmit to the control terminal a configuration message including a configuration related to the grouping.
   (7)

The mobile communication system according to (6) described above,
wherein the configuration message includes at least one selected from the group consisting of information designating the number of the plurality of groups to be configured for the relay apparatus and/or the number of the beams to be configured for the relay apparatus, identifiers of one or more groups of the plurality of groups to be associated with each beam, and an identifier of the user equipment to be associated with each of the plurality of groups or each beam.
   (8)

The mobile communication system according to (6) or (7) described above,
wherein the configuration message includes a plurality of the configurations that are switched in a time division manner.
   (9)

The mobile communication system according to (8) described above,
wherein, in the configuration message, each of the plurality of the configurations is associated with a configuration identifier, and
the base station transmits to the control terminal a control indication in which the configuration identifier designates a configuration of the plurality of the configurations to be applied.
   (10)

A control terminal configured to control a relay apparatus, the relay apparatus being configured to relay a radio signal between a base station and one or more user equipments and including a plurality of elements used for beamforming, the control terminal including:
a controller configured to perform, by grouping the plurality of elements into a plurality of groups, independent beam control for each of the plurality of groups; and
a communicator configured to communicate information on the plurality of groups with the base station.

### REFERENCE SIGNS

1: Mobile communication system
100: UE
100B: NCR-UE
100C: RIS-UE
110: Receiver
120: Transmitter
130: Controller
140: Interface
200: gNB
210: Transmitter
220: Receiver
230: Controller
240: Backhaul communicator
500A: NCR apparatus
500B: RIS apparatus
510A: Wireless unit
510a: Antenna
510b: RF circuit
510c: Directivity controller
511A: Group
511B: Group
512: PA
513: Phase shifter
514: Antenna
515: Structure
520A: NCR controller
520B: RIS controller

1. A mobile communication system, comprising:
a base station;
a relay apparatus configured to relay a radio signal between the base station and a user equipment; and
a control terminal configured to communicate with the base station and control the relay apparatus,
wherein the relay apparatus comprises a plurality of elements used for beamforming,
the control terminal performs, by grouping the plurality of elements into a plurality of groups, independent beam control for each of the plurality of groups, and
information on the plurality of groups is communicated between the base station and the control terminal.

2. The mobile communication system according to claim 1,
wherein the relay apparatus is a repeater apparatus configured to amplify and transfer a received radio wave, and
each of the plurality of elements comprises an antenna of the repeater apparatus.

3. The mobile communication system according to claim 1,
wherein the relay apparatus is a Reconfigurable Intelligent Surface (RIS) apparatus configured to change a propagation direction of an incident radio wave by reflection or refraction, and
each of the plurality of elements comprises a structure for the RIS apparatus.

4. The mobile communication system according to claim 1,
wherein the control terminal is configured to transmit capability information comprising information indicating the number of the plurality of groups to the base station.

5. The mobile communication system according to claim 4,
wherein the capability information further comprises at least one selected from the group consisting of information indicating the number of the plurality of elements in each of the plurality of groups in the relay apparatus, the number of all the plurality of elements in the relay apparatus, an identifier of each of the plurality of groups in the relay apparatus, and information indicating beam characteristics of each of the plurality of groups in the relay apparatus.

6. The mobile communication system according to claim 1,
wherein the base station is configured to transmit to the control terminal a configuration message comprising a configuration related to the grouping.

7. The mobile communication system according to claim 6,
wherein the configuration message comprises at least one selected from the group consisting of information designating the number of the plurality of groups to be configured for the relay apparatus and/or the number of the beams to be configured for the relay apparatus, identifiers of one or more groups of the plurality of groups to be associated with each beam, and an identifier of the user equipment to be associated with each of the plurality of groups or each beam.

8. The mobile communication system according to claim 6,
wherein the configuration message comprises a plurality of the configurations that are switched in a time division manner.

9. The mobile communication system according to claim 8,
wherein, in the configuration message, each of the plurality of the configurations is associated with a configuration identifier, and
the base station transmits to the control terminal a control indication in which the configuration identifier designates a configuration of the plurality of the configurations to be applied.

10. A control terminal configured to control a relay apparatus, the relay apparatus being configured to relay a radio signal between a base station and one or more user equipments and comprising a plurality of elements used for beamforming, the control terminal comprising:
a controller configured to perform, by grouping the plurality of elements into a plurality of groups, independent beam control for each of the plurality of groups; and
a communicator configured to communicate information on the plurality of groups with the base station.
